(19) United States
(12) Patent Application Publication
(10) Pub. No.: US 2006/0069761 A1
(43) Pub. Date: Mar. 30, 2006

(54) System and method for load balancing virtual machines in a computer network

(75) Inventors: Sumankumar A. Singh, Pflugerville, TX (US); Timothy E. Abels, Pflugerville, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 10/940,071

(22) Filed: Sep. 14, 2004

(51) Int. Cl. G06F 15/177

(52) U.S. Cl. 709/222

(57) ABSTRACT

A system and method for balancing the load of virtual machines among the physical servers of a network is disclosed. When a server of the network is identified as exceeding its total resource utilization, a virtual machine within the server is selected for migration to another physical server within the network. A virtual machine may be selected for migration on the basis of an identification of the virtual machine that has the lowest level of resource requirements. The target physical server may be selected on the basis of an identification of a server that has the highest level of resource availability.

### TECHNICAL FIELD

The present disclosure relates generally to the field of networks, and, more particularly, to a system and method for the load balancing of virtual machines in a computer network.

### BACKGROUND

As the value and use of information continues to increase, individuals and businesses continually seek additional ways to process and store information. One option available to users of information is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary with regard to the kind of information that is handled, how the information is handled, how much information is processed, stored, or communicated, and how quickly and efficiently the information may be processed, stored, or communicated. The variations in information handling systems allow for information handling systems to be general or configured for a specific user or specific use, including such uses as financial transaction processing, airline reservations, enterprise data storage, or global communications. In addition, information handling systems may include a variety of hardware and software components that may be configured to process, store, and communicate information and may include one or more computer systems, data storage systems, and networking systems.

Computers, including servers and workstations, are often grouped into computer networks, including networks having a client-server architecture in which the servers access storage, including shared storage, in response to requests from client computers of the network. The servers of a computer network may include one or more virtual operating systems running on the host operating system and the host software of the server. Each virtual operating system comprises a virtual machine. Multiple virtual machines may be included on a single physical server. The presence of one or more virtual machines on a single physical machine provides a separation of the hardware and the software of the compute system. Each virtual machine could be dedicated to the task of handling a single function. As an example, one virtual machine could be mail server, while another virtual machine present on the same physical server could be a file server.

### SUMMARY

In accordance with the present disclosure, a system and method for balancing the load of virtual machines among the physical servers of a network is disclosed. When a server of the network is identified as exceeding its total resource utilization, a virtual machine within the server is selected for migration to another physical server within the network. A virtual machine may be selected for migration on the basis of the virtual machine that has the lowest level of resource requirements. The target physical server may be selected on the basis of an identification of a server that has the highest level of resource availability.

The system and method disclosed herein provides an efficient technique for the balancing of virtual machines among the physical servers of a computer network. When a server of the computer network becomes overloaded, at least one of the virtual machines of the server is migrated to another server, thereby relieving some of the demands on overloaded system. Because the system and method disclosed herein prevents the servers of the computer network from reaching an overloaded state, the resources of the network are optimized, and the network does not reach a state in which the applications running on a single server are competing for resources.

Another technical advantage of the present invention is that it is not limited in its use to computer networks having a limited number of servers or a limited number of virtual machines within each server. The system and method disclosed herein is operable within networks having multiple servers and multiple virtual machines within each server. Another technical advantage of the system and method disclosed herein is that the system and method may be used for the sake of locating new virtual machines within the network. When a new virtual machine is placed in the network, the system and method disclosed herein automatically migrates the virtual machine if it is determined that the virtual machine or another virtual machine of the server if the addition of the virtual machine causes the server to exceed a predetermined threshold. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a computer network;

FIG. 2 is diagram of the communication flow between elements of server nodes and elements of a control node; and

FIG. 3 is a flow diagram of a method for selecting a virtual machine for migration from one physical machine to another physical machine.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. An information handling system may comprise one or more nodes of a cluster network.

The system and method disclosed herein provides a technique for load balancing among the servers of a computer network. Each server of the computer network may host one or more virtual machines. When the resource utilization of any physical machine of the computer network exceeds a predetermined threshold, a virtual machine of the server node is selected for migration to another server of the computer network. The system and method disclosed herein concerns the intelligent selection of a virtual machine of an overutilized server for transfer to another server of the computer network.

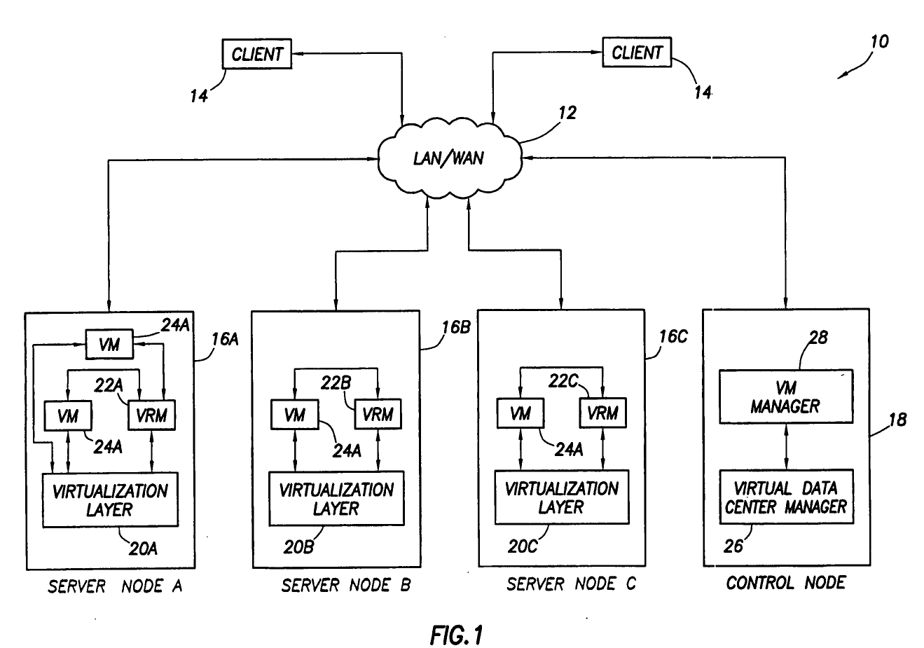

Shown in FIG. 1 is a diagram of a server network, which is indicated generally at 10. Server cluster network 10 includes a LAN or WAN node 12 that is coupled to client nodes 14. LAN/WAN node 12 is coupled in this example to three server nodes, which are identified as Server Node A, Server Node B, and Server Node C. The servers of FIG. 1 may perform any server function and may comprise, for example, data servers, application servers, or web servers. Each of the server nodes will be referred to herein as physical nodes or servers to contrast these nodes with the virtual machines running on each of the servers. The elements of each server are identified with an alphabetical prefix that corresponds with an alphabetical indicator associated with the server node. Each server node 16 includes a virtualization layer 20, which separates the hardware and software of the physical server that supports the virtual machines running on the server. Virtualization layer 20 includes the hardware of the server, the operating system of the server, and the virtual system software that runs on the operating system of the server and supports each virtual machine of the server. As indicated in each of the servers 16, a virtual machine 24a is supported by and communicates with the virtualization layer. Server Node A includes two virtual machines 24A, while the other servers of the computer network of FIG. 1 include one virtual machine 24.

Each server 16 includes a virtual resource manager (VRM) 22. Virtual resource manager 22 controls the amount of physical resources of the server that are being allocated to each of the virtual machines hosted by the server. These physical resources that are rationed by virtual resource manager 22 include the processing capacity of the processor or processors of the server and the memory of the server 16. Virtual resource manager 22 also maintains a record of the resource utilization requirements of each virtual machine of the associated server 16. The resource requirement of each virtual machine 24 of a server is the maximum amount of resources that, depending on the operational status of the virtual machine, could be consumed by the virtual machine. Virtual resource manager 24 is also able to identify the total resource utilization of the server. The total resource utilization of a server is a snapshot of the resource utilization of the server. The total resource utilization of a server may be expressed as a percentage of the maximum possible resource utilization of the server. As indicated in FIG. 1, each virtual machine 24 is able to exchange data with the virtual resource manager 22 of the server. Each virtual machine 24 and the virtual resource manager 22 of the server communicate with the virtualization layer of the server.

Network 10 also includes a control node 18, which is coupled to the LAN/WAN node 12. Control node 10 includes a virtual machine manager 28 and a virtual data center manager 26. Virtual data center manager 10 operates in a centrally accessible location in network 10 and receives from each of the virtual resource managers 22 of each of the servers 16 (a) the resource utilization requirements of each of the virtual machines within network 10 and (b) the total resource utilization of each server. The resource utilization requirements of each virtual machine and the total resource utilization of each server comprise a global resource map that identifies for the virtual data center manager the resources required by each of the virtual machines and the resources currently being consumed by each of the physical servers of the computer network. Virtual machine manager 28 communicates with the virtual data center manager 26 and, upon receiving a command from virtual data center manager 26, is operable to migrate a virtual machine from a first physical server to a second physical server. An example of a virtual machine manager is VMotion of EMC Corporation of Hopkinton, Mass.

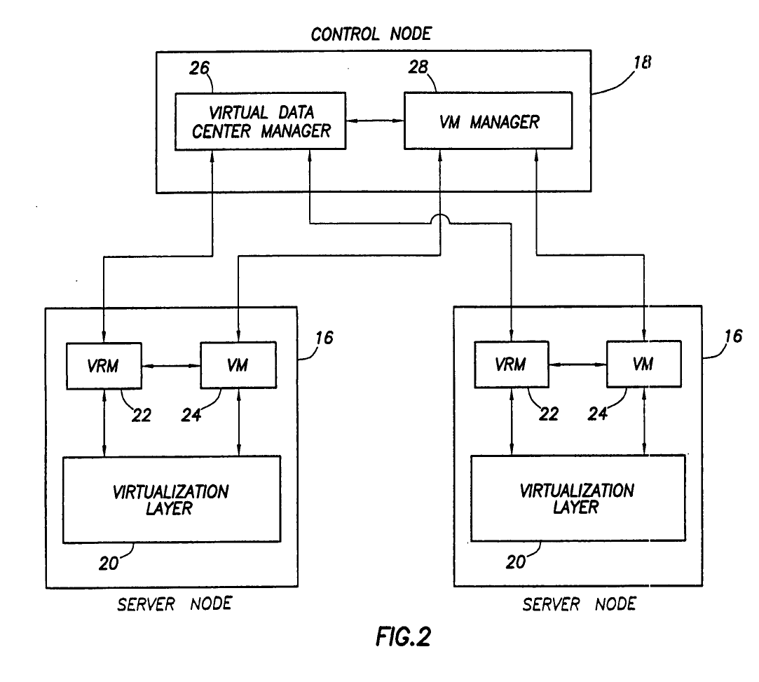

A diagram of the communication links between the modules of a server node 16 and the modules of a control node 18 are shown in FIG. 2. Each virtual resource manager 22 is operable to communicate with the virtual data center manager 26 of control node 18, and each virtual machine 24 is operable to communicate with the virtual machine manger 28. In this manner, virtual machine manger 22 communicates to the virtual data center manager 26 information concerning the resource utilization requirements of each virtual machine and the total resource utilization of each server. On the basis of this information, data center manager 26 may communicate this information to virtual machine manager 28, which can manage the migration of a virtual machine from one physical server to a second physical server.

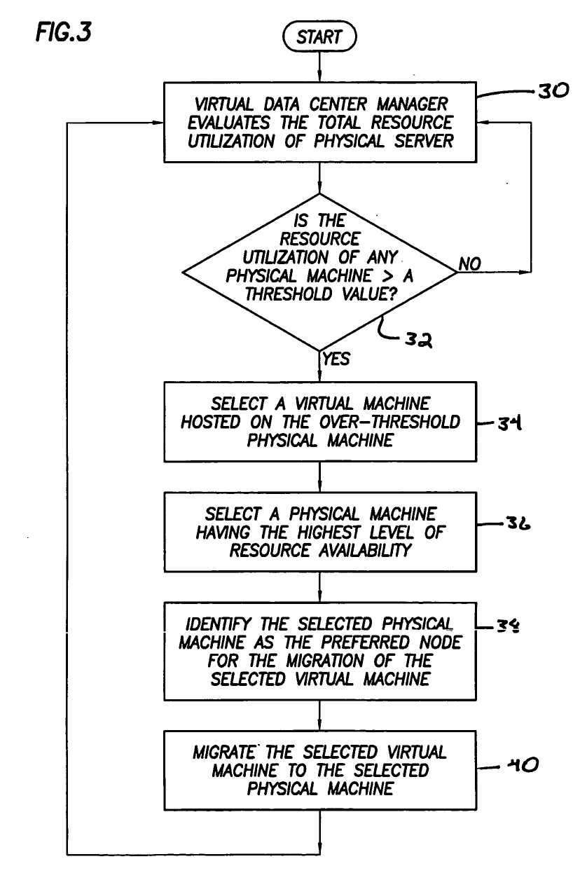

Shown in FIG. 3 is a flow diagram of a series of method steps for monitoring the total resource utilization of each physical service and for selecting a virtual machine for migration from a first physical server to a second physical server. At step 30, virtual data center manager 26 continuously monitors the total resource utilization of each physical server of the computer network. To accomplish the monitoring of step 30, virtual data center manager 26 may perform continuous scans and communicate with the virtual resource manager of each physical server to insure that the virtual data center manager has an accurate snapshot of the total resource utilization of the server. At step 32, the virtual data center manager determines whether the resource utilization of any physical server of the network exceeds a predetermined threshold value. This threshold value may be a measure of the processor resources of the physical server, the memory resources of the physical server, or both. The threshold value may be expressed as a percentage and may be expressed as a measure that reflects both the processor and memory resources of the physical server. If it is determined at step 32 that none of the physical machines of the server exceed the threshold value, the flow diagram loops to the continuous scans of the resource utilization of each physical server at step 30.

If it is determined that the resource utilization of a physical server of the network has exceeded a predetermined threshold, a virtual machine of the server is selected. A server whose total resource utilization exceeds a certain threshold is sometimes referred to as a source server. If the physical server includes multiple virtual machines, a virtual machine could be selected according to one of several techniques. As a first alternative, the virtual machine having the lowest resource utilization requirements could be selected. The virtual machine having the lowest resource utilization requirements is consuming a relatively limited set of resources as compared with other virtual machines in the network. As such, the virtual machine having the lowest resource utilization requirements among the virtual machines of the physical server is the virtual machine that is best candidate, because of its limited consumption requirements, to be moved to an other physical server in the network.

As an alternative to selecting the virtual machine having the lowest resource utilization requirements, the virtual machines of the physical server could be ranked for migration to a second server. The process of migrating a virtual machine may involve an interruption in the operation of the virtual machine. As such, those virtual machine that, for business or technical reasons, are poor candidates for an interruption in operation are identified as having a low priority for migration. Those virtual machines that are the most tolerant of an interrupt in operation are given a high priority for migration. As part of the selection step 34, the virtual machine having the highest priority for migration is selected for migration.

Once a virtual machine is selected at step 34, the physical server having the highest level of resource availability is selected at step 36. The level of resource availability of each server is determined by subtracting the total resource utilization of each server from the maximum resource utilization of each server. The physical server identified in step 32 is not included in the set of servers that could be selected in step 36. At step 38, the server selected at step 36 is identified for virtual machine manager 28 as the target server or preferred node for the migration of the selected virtual machine. At step 40, virtual machine manager 28 migrates the selected virtual machine to the server selected at step 38 as the target server. The process then loops back to step 30 for the continuous scan of the total resource utilization of each virtual machine.

The load balancing technique described herein can be used without first identifying a physical server whose total resource utilization exceeds a predetermined threshold. When a new virtual server is added to the network, the technique of the present disclosure can be used to identify the physical server having the highest level of resource availability.

The system and method described herein may be used in computer networks having multiple servers and in computer networks in which one or more of the servers includes multiple virtual machines. Although the present disclosure has been described in detail, it should be understood that various changes, substitutions, and alterations can be made hereto without departing from the spirit and the scope of the invention as defined by the appended claims.

What is claimed is:

1. A method for migrating a virtual machine from a first physical server in a computer network, comprising the steps of:
identifying, within the computer network, a server whose total resource utilization exceeds a predetermined threshold, wherein the identified server is known herein as the source server;
identifying a virtual machine within the source server; and
identifying a target server for the migration of the identified virtual machine; and
migrating the identified virtual machine from the source server to the target server.

2. The method for migrating a virtual machine of claim 1, wherein the step of identifying a server whose total resource utilization exceeds a predetermined threshold comprises the step of identifying a server whose use of processor resources exceeds a predetermined threshold.

3. The method for migrating a virtual machine of claim 1, wherein the step of identifying a server whose total resource utilization exceeds a predetermined threshold comprises the step of identifying a server whose use of memory resources exceeds a predetermined threshold.

4. The method for migrating a virtual machine of claim 1, wherein the step of identifying a server whose total resource utilization exceeds a predetermined threshold comprises the step of identifying a server whose use of memory resources and processor resources exceeds a predetermined threshold that is a measure of both memory resources and processor resources.

5. The method for migrating a virtual machine of claim 1, wherein the step of identifying a virtual machine within the source server comprises the step of identifying the virtual machine within the source server that has the lowest resource utilization requirements among the virtual machines of the source server.

6. The method for migrating a virtual machine of claim 1, wherein the step of identifying a virtual machine within the source server comprises the step of identifying the virtual machine within the source server that is previously identified as being the virtual machine of the source server that is the most tolerant of an interruption in operation.

7. The method for migrating a virtual machine of claim 1, wherein the step of identifying a target server for the migration of the identified virtual machine comprises the step of identifying, among the servers of the computer network not including the source server, the server having the highest level of resource availability.

8. The method for migrating a virtual machine of claim 1, wherein the step of migrating the identified virtual machine from the source server to the target server comprises the steps of:
identifying the target server and the selected virtual machine to a migration module and causing the migration module to migrate the selected virtual machine from the target server to the source server.

9. A computer network, comprising:
a plurality of physical servers, wherein each of the physical servers includes at least one virtual machine running thereon; and
a control server for monitoring the operation of the virtual machines of the physical servers and operable to perform the function of migrating a virtual machine from one physical server to another when it is determined that the total resource utilization of one of the physical servers of the network exceeds a predetermined threshold.

10. The computer network of claim 9,
wherein the control server is operable to identify for migration a virtual machine within the physical server whose total resource utilization is determined as exceeding a predetermined threshold; and
wherein the control server is able to identify the virtual machine for migration by identifying the virtual machine, within the physical server, having the lowest resource utilization requirements.

11. The computer network of claim 9,
wherein the control server is operable to identify for migration a virtual machine within the physical server whose total resource utilization is determined as exceeding a predetermined threshold; and
wherein the control server is able to identify the virtual machine for migration by identifying the virtual machine, within the physical server, that is identified as being the best candidate for an interruption in service.

12. The computer network of claim 9, wherein the control server identifies a server for receipt of the migrated virtual machine by identifying the physical server having the highest level of resource availability.

13. The computer network of claim 9, wherein the predetermined threshold associated with each physical server is a function of the available processor resources of each physical server.

14. The computer network of claim 9, wherein the predetermined threshold associated with each physical server is a function of the available memory resources of each physical server.

15. The computer network of claim 9, wherein the predetermined threshold associated with each physical server is a function of the available memory resources and the processor resources of each physical server.

16. A method for balancing the virtual machines among the servers of a computer network, comprising the steps of:
periodically scanning each of the servers to determine if any of the servers have a total resource utilization characteristic that exceeds a predetermined threshold;
identifying among the servers of the network a first server whose total resource utilization characteristic exceeds a predetermined threshold;
identifying within the first server a virtual machine for migration;
identifying a target server for the migration of the virtual machine; and
migrating the virtual machine from the first server to the target server.

17. The method for balancing the virtual machines among the servers of a computer network of claim 16, wherein the step of identifying within the first server a virtual machine for migration comprises the step of identifying the virtual machine, within the first server, that has the lowest resource utilization requirements.

18. The method for balancing the virtual machines among the servers of a computer network of claim 16, wherein the step of identifying within the first server a virtual machine for migration comprises the step of identifying the virtual machine, within the first server, that is identified as being a candidate for an interrupt in operation.

19. The method for balancing the virtual machines among the servers of a computer network of claim 16, wherein the step of identifying a target server for the migration of the virtual machine comprises the step of identifying, from among the set of servers not including the first server, the server having the highest level of resource availability.

20. The method for balancing the virtual machines among the servers of a computer network of claim 16, wherein the step of migrating the virtual machine from the first server to the target server comprises the step of identifying the identified virtual machine and target server to a virtual machine manager module in a control node and causing the virtual machine manager module to migrate the identified virtual machine to the target server.
